(19) United States
(12) Patent Application Publication
(10) Pub. No.: US 2016/0027084 A1
(43) Pub. Date: Jan. 28, 2016

(54) Delivery of Product Safety Information

(71) Applicant: ely Technologies, Inc., San Diego, CA (US)

(72) Inventor: Ria Otero, San Diego, CA (US)

(21) Appl. No.: 14/808,598

(22) Filed: Jul. 24, 2015

Related U.S. Application Data
(60) Provisional application No. 62/028,796, filed on Jul. 24, 2014.

(51) Int. Cl. G06Q 30/06; G06Q 50/26; G06Q 30/00

(52) U.S. Cl. CPC G06Q 30/0627; G06Q 30/0607; G06Q 30/014; G06Q 50/265

(57) ABSTRACT

A method and system for delivering product safety information. The method may include receiving a product name and searching a database of existing products for matching products. The method may comprise presenting matching products and an option to select a matching product to save, and receiving a selection from the user regarding the matching product. The method may include saving a matching product selected by the user in an inventory, thereby creating a saved product. The saved product may be compared to one or more databases of past recalled products. If a past recall of the saved product is found in the one or more databases, a notification may be presented to the user. New recall databases may be accessed continuously and periodically in order to identify new recalls issued against the saved product, and if a new recall is issued, a visual alert to the user may be created.

### CROSS REFERENCE TO RELATED APPLICATIONS

The present Application for Patent claims priority to Provisional Application No. 62/028,796, entitled “DELIVERY OF PRODUCT SAFETY INFORMATION” filed Jul. 24, 2014, and assigned to the assignee hereof and hereby expressly incorporated by reference herein.

### FIELD OF THE DISCLOSURE

The present disclosure relates generally to applications for delivering product safety information on personal computing devices. In particular, but not by way of limitation, the present disclosure relates to systems, methods and apparatuses for mobile and web applications for tracking, reporting and relaying product safety recall information to consumers.

### BACKGROUND

When consumer products are deemed to be dangerous or potentially dangerous by a product manufacturer or a regulatory body, recalls are issued against the product. One main purpose of product recalls is to alert consumers who have the product in their possession and prevent future harm that may be caused by the product. Product manufacturers typically offer remedies such as repairs, replacements, or refunds to customers who have recalled products in their possession. Many logistical challenges exist to distributing pertinent recall information to a large number of consumers. In particular, when a large number of products have been sold, it is nearly impossible to ensure that all, or even most consumers who have purchased the product will become aware of the recall information. Past methods of issuing recalls have included press releases, media reports, flyers at large retail stores, and mailers to registered product owners. More recently, the internet has enabled consumers to find information on product recalls by searching for it, signing up for e-mail alerts, and by reading information spread on social media.

Even for consumers who are concerned and vigilant enough to check online sources for recall information would find it a daunting task to search these sources for information that was personally relevant to them. That is, determining whether one owns a recalled product requires not only knowing what products have been recalled, but what specific products one personally owns. Improvements are desired in the ability to compare one's own products to the universe of recalled products.

### SUMMARY

An aspect of the disclosure provides a method for delivering product safety information using an application on a personal computing device. The method may comprise receiving, as a result of a user-initiated action, at least a portion of a product name of a product, and then searching a database of existing products for existing products matching the at least a portion of the product name. The method may further comprise presenting, to a user, if one or more matching products is found in the database of existing products, an option to select one of the one or more matching products to save, and then receiving a selection from the user of one of the one or more matching products. Next, the method may include saving one of the one or more matching products selected by the user in an inventory in a memory, thereby creating a saved product, and comparing the saved product to one or more databases of past recalled products. If a past recall of the saved product is found in the one or more databases, the method may comprise presenting a notification to the user. The method may also comprise accessing one or more new recall databases continuously at specified intervals of time in order to identify new recalls issued against the saved product and creating a visual alert to the user if a new recall is issued against the saved product.

Another aspect of the disclosure provides a system for providing product safety information. The system may comprise a personal computing device, which itself comprises a user interface for inputting at least a portion of a product name and an application implemented on a hardware processor. The application itself may comprise an existing product database comparison module, a past recall database comparison module, a new recall check and comparison module, and an alert module. The personal computing device may also comprise a memory for storing an inventory and a transceiver. The system may further comprise at least one existing product database, at least one past recall database, and at least one new recall database.

An aspect of the disclosure provides a non-transitory, tangible computer readable storage medium, encoded with processor readable instructions to perform a method for delivering product safety information using an application on a personal computing device. The method may comprise receiving, as a result of a user-initiated action, at least a portion of a product name of a product, and then searching a database of existing products for existing products matching the at least a portion of the product name. The method may further comprise presenting, to a user, if one or more matching products is found in the database of existing products, an option to select one of the one or more matching products to save, and then receiving a selection from the user of one of the one or more matching products. Next, the method may include saving one of the one or more matching products selected by the user in an inventory in a memory, thereby creating a saved product, and comparing the saved product to one or more databases of past recalled products. If a past recall of the saved product is found in the one or more databases, the method may comprise presenting a notification to the user. The method may also comprise accessing one or more new recall databases continuously at specified intervals of time in order to identify new recalls issued against the saved product and creating a visual alert to the user if a new recall is issued against the saved product.

### BRIEF DESCRIPTION OF THE DRAWINGS

FIG. 1 shows a product input screen of an application in accordance with an aspect of the present disclosure.

FIG. 2 shows a product adding screen of an application in accordance with an aspect of the present disclosure.

FIG. 3 shows an inventory list screen of an application in accordance with an aspect of the present disclosure.

FIG. 4 is a flowchart depicting a method that may be performed in accordance with an aspect of the present disclosure.

FIG. 5 shows a logical block diagram of a computing device and components thereof that may implement aspects of the present disclosure.

FIG. 6 shows a past recall check screen of an application in accordance with an aspect of the present disclosure.

FIG. 7 is a flowchart depicting a method that may be performed in accordance with an aspect of the present disclosure.

FIG. 8 is a logical block diagram of a computing device that may implement aspects of the present disclosure.

FIG. 9 shows a push notification screen that may be presented to a user of an application in accordance with an aspect of the present disclosure.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Many consumer products throughout the world are regulated by various supervisory bodies that implement various regulatory regimes. Consumer products in the United States, for example, are regulated according to the type of product. A few types of products have significant approval requirements prior to being sold, and have ongoing monitoring and reporting requirements while on the market. Examples of such products are food and drugs regulated by the FDA, transportation vehicles regulated by the NTSB, and alcohol, tobacco, and firearms regulated by the ATF. The vast majority of consumer products are regulated by the Consumer Safety Protection Bureau (CSPC), and most of these products do not face significant approval requirements before being put on the market. Products for children do face more safety standards, such as those regarding materials (e.g., pajamas cannot be made of certain flammable materials, paint cannot contain lead, etc.) and size and shape (e.g., no small parts for children under a certain age, straps and strings must be under a certain length, etc.). Often, dangerous and deadly product defects are only discovered through accidents that injure consumers, well after the products have been widely distributed and sold. Sometimes product features that do not initially appear to be dangerous are discovered to be so only after wide product use. Such discoveries occur commonly with children's products, given that children are typically less able to help themselves out of dangerous situations the younger they are. For example, laying on a table or sleeping next to an object can be dangerous for infants, and is less so the older they are. Children often do not understand that they can be hurt by their own actions, such as swallowing something or touching a sharp object. Defects, dangerous features, and their related injuries or deaths are often reported to the manufacturers themselves and to the CSPC. Ultimately, because consumers, the government, and manufacturers themselves have an important interest in consumer safety, nearly all products with dangerous defects, or even dangerous features that would not normally be thought of as defects, end up being recalled.

Recalls can take a variety of forms. For example, product safety recalls in the United States usually involve a government agency such as the CPSC, but on some occasions they do not, and in those cases only the manufacturer initiates and is responsible for the recall. There are also manufacturer-initiated recalls that are not safety related, but rather quality related. Within the subset of recalls that involve the CPSC, there are voluntary and involuntary recalls. The vast majority of recalls are voluntary, meaning that the agency did not have to sue a manufacturer to force the recall. However, the label “voluntary” does not mean safety issue is any less serious than that in an involuntary recall. Product recalls involve various remedies, such as the manufacturer sending a free replacement part to the consumer for the consumer to install, or the manufacturer requesting that a product be sent back for a free repair or replacement, or a manufacturer pulling a product off the market altogether and issuing the consumer a refund. All remedies available by recall require some level of consumer awareness and involvement.

Currently, the ways by which consumers are notified of recalls is a patchwork of advertising methods and information campaigns that often only obtain marginal results. Rarely, a recall will gain significant media coverage because the product defect is so dangerous and affects such a large number of units in the marketplace. However, even when recalls are reported by major news outlets on television and the internet, many consumers who own those recalled products don't hear about them. They may miss the news broadcast or not read the news on their home internet screen. Parents of young children, especially, are apt to miss even the most widely reported news. For recalls of less widely distributed products, manufacturers must try to reach their purchasers through non-news media campaigns. These campaigns include posters near the doors of large retailers such as Walmart®, Target®, Toys a′ Us®, and similar companies. Such posters are easily ignored. Manufacturers can also mail information to consumers who register their products by mail or the internet, but even the best product registration responses reach only a small percentage of their purchasers. An inherent impediment to reaching consumers is that a recall is a costly event for a manufacturer, not only in actual replacement cost but in loss of reputation and future sales as well. There is little incentive for a manufacturer to spend large amounts of money on advertising a process that causes it to lose money. Government agencies such as the CPSC provide information about every product safety recall with which it is involved. However, that information is only available to consumers when they take the steps of going to the website and looking up the information. Alert e-mails are available to those who sign up for them, but those e-mails cover all recalled products, not just the ones the consumer happens to own or is thinking about purchasing. For the above reasons, a need exists for a way to deliver relevant and timely recall information to purchasers and prospective purchasers of consumer products.

One aspect of the current disclosure comprises a mobile or web application that has an interface with which consumers can interact. It is contemplated that embodiments of this disclosure can exist on either a mobile application (“mobile app”) or a web application (“web app”), although many of the functions will be described presently in the context of a mobile app on a mobile device such as a smartphone or tablet computer. In various embodiments, a mobile app on a mobile device can provide advantages in ease of use and functionality over a web app on, for example, a desktop computer. However, features described herein, which are described in the context of a mobile app on a mobile application, shall be construed as applicable to embodiments within a web application whenever possible.

Another aspect of this disclosure is a web application with an administrator interface, the details of which will be described presently. The administrator web application can be hosted on a network and provide an application program interface (API) between the user's mobile or web application and the administrator-interfacing web application. For ease of differentiation between the two types of web applications, a user-interfacing web application will be referred to herein as a “user web app,” and an administrator-interfacing web application will be referred to herein as an “admin web app.”

One embodiment of the present disclosure comprises a mobile application (which may be referred to herein as a “mobile app” or as an “application”) on a mobile device such as a phone, tablet computer, watch, wearable device, or any other personal computing device with a graphical user interface. Throughout the disclosure, reference may be made to a “mobile device,” which generally refers to any personal computing device disclosed herein. A mobile app of the present disclosure can be downloaded onto any mobile device with an operating system that supports an app environment, such as through Apple® or Android® operating systems, which are well known in the art. In one embodiment, the mobile app can receive and store input from the user regarding products the user already owns. A list of the consumer products a mobile app user owns is referred to herein as the user's “inventory.” Other names for an inventory may be used in some embodiments, such as a “list,” “trunk,” “storage,” “container,” “file,” “library,” or any other names that connote the concept of storing information for future reference. The inventory can be stored through the application on local memory or on memory or a server associated with the admin web app. The inventory can comprise a list including information such as the manufacturer, product name, serial number, date purchased, associated past recalls, user manuals, registration information, safety ratings, images, optical recognition data, and any other information related to the product.

Inventory information can be used to match a mobile app user's inventory with two categories of recalls. The first category is past recalls affecting products that are entered into the inventory. A user who attempts to enter a product that has previously been recalled into an inventory will be notified immediately of the past recall, and ideally will use the information to ensure the dangers associated with the product are remediated, either by discarding or replacing the product. The second category is new recalls issued against stored products in the inventory as they occur. The methods by which notifications regarding these recalls occur will be described later in this disclosure.

One benefit of matching the user's particular inventory with product recalls is that only information that is relevant to the user will be delivered. Product recalls occur all the time, but unless a consumer owns the actual product that is the subject of a recall, information about recalls generally is not useful to the consumer. Even consumers that are concerned and vigilant about seeking out recall information are at risk of missing important information when they are also inundated with irrelevant information. For example, a consumer that signs up for e-mail alerts regarding recalls from the CPSC will get e-mails for all products, including products the consumer does not own. It would be easy for a consumer to start ignoring the e-mails after receiving dozens of inapplicable ones. Additionally, recalls often only affect a subset of a manufacturer's product line, and even within a product line, they may only affect a certain model or set of serial numbers. Consumers typically must read recall information closely and compare it to their own products in order to determine whether the recall applies to their particular products.

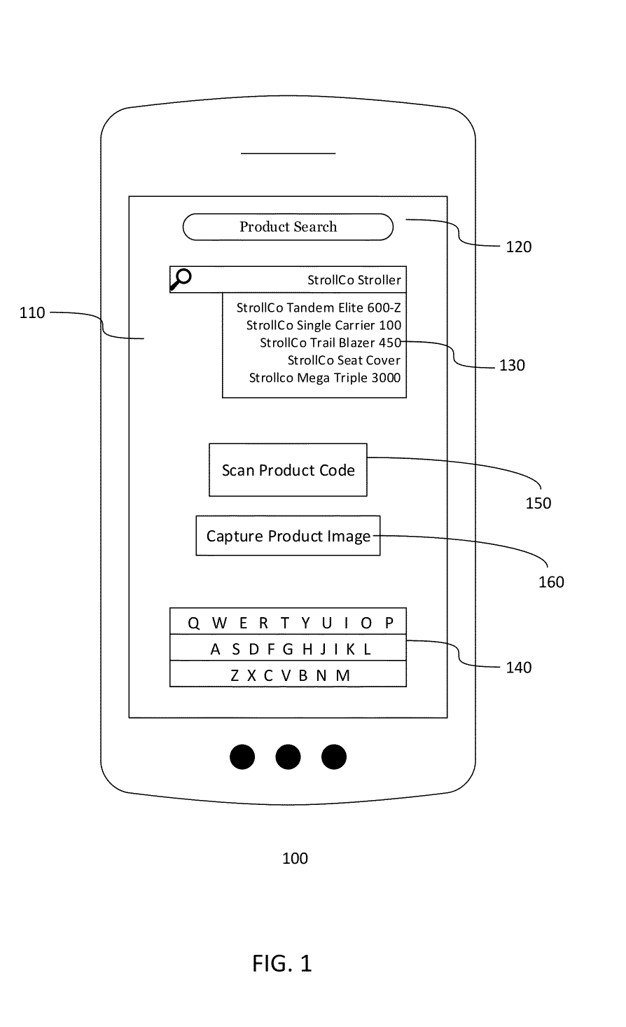

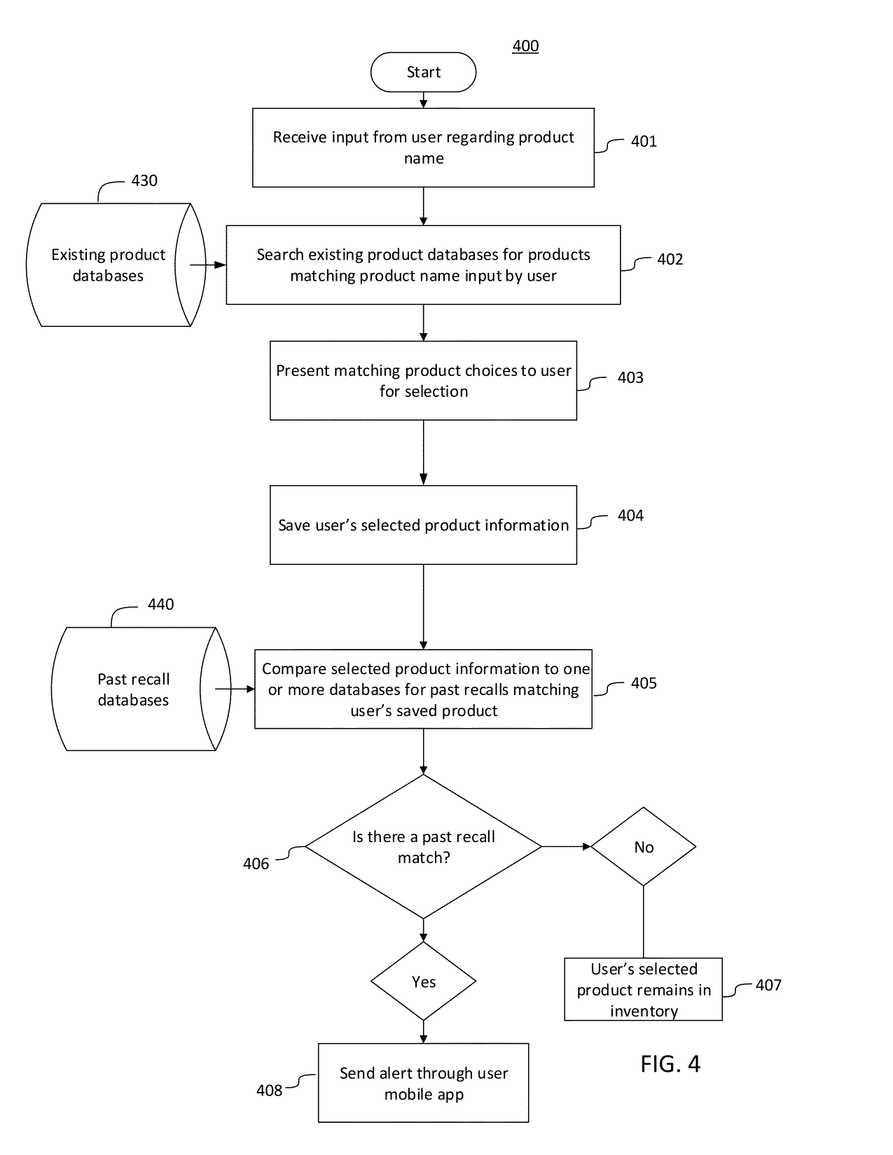

Turning now to FIG. 1, shown is an exemplary personal computing device 100, with a graphical user interface, displaying a product input screen 110 of the app in accordance with an embodiment of the present disclosure. The product input screen 120 has an input field 120 into which a user may input a product name, or at least part of a product name. In some embodiments, users of the mobile or user web application can type in manufacturer names, product names, model names, model numbers, serial numbers, or various combinations thereof to add the product to inventory. A user may user a touchscreen keyboard 140, as known in the art, to type in all or part of a product's identifying information. Several embodiments of this kind of “manual entry” are contemplated. The input field 120 may have an associated “search” or “auto-complete” drop-down menu 130. In another embodiment, the field into which a manual entry is made can be linked to an existing product database, which may be derived from government agency databases, manufacturer's product databases, and other sources. The existing product database can be hosted, managed, or even created by the admin web app. Referring briefly to FIG. 4, the method 400, at 402, shows how the app can search existing product databases 430 in order to find matching products that match the portion of the product name that has been input by the user. The input field 120 can also be configured to auto-complete suggestions for products within the manufacturer's databases according to matches that remain after each letter or number entry. In one embodiment, the input field 120 into which the manual entry is made can be linked to a search engine, such that the search engine's auto-complete suggestions for popular matches can appear and be narrowed down as more letters and numbers are entered into the field. A benefit to auto-complete suggestions from either an existing product database, a search engine database, manufacturer database, or any other kind of database is that it can reduce errors made by manual entry. Another benefit is that it can encourage users to actually enter their products, rather than have them be discouraged that they have to manually enter them. A busy parent may find it inconvenient to enter an entire manufacturer name, product name, and even model number, such as “Graco Stylus LX Travel System—Winslet,” or “Playmobil 6787 Santa Claus with Reindeer Sleigh,” or “Million Dollar Baby Classic Foothill Convertible Crib with Toddler Rail—Finish: Weathered Grey.” If the user can narrow down choices by typing just “graco stylus,” “playmobil santa,” or “foothill crib,” fewer obstacles exist to actually entering inventory.

A variety of ways to input inventory are contemplated. Several aspects of this disclosure pertain to systems and methods that increase the likelihood that a user will actually enter their products in inventory consistently and accurately. To that end, the embodiments described herein for inputting inventory may be used in various combinations with each other. In some embodiments, a user can scan a UPC barcode using a smartphone camera to obtain product identification data. FIG. 1 shows a “scan product code” button 150 that may be presented to the user to initiate a scanning option. Alternatively, a user can type in the numerical UPC code that is associated with the barcode. Such barcode scanners using smartphone cameras are known in the art, and indeed, barcode scanning or UPC numerical code entry to match up to recall information is also known in the art. An advantage of barcode scanning is that it is highly reliable, because UPC codes are uniform, institutionalized, and matched up to their correct products with a high degree of precision. However, once products are removed from their packaging, they usually do not have barcodes on them. There are a number of instances in which a parent might possess a product without a barcode. For example, a parent might purchase and open a product and then throw away the packaging before scanning the code to add it to the inventory. A parent may receive hand-me-down toys, clothes, and other children's products from friends or relatives. A parent may purchase used toys, clothes, or other children's products from consignment stores or online. Therefore, it is beneficial to have multiple ways to enter inventory other than a barcode scan.

In some embodiments, images of inventory products can be viewable within the application. For example, when a user is entering a product name in the input field 120, a thumbnail image can appear, prompting the user to confirm whether the image matches the user's actual products. The thumbnail image can be enlarged or reduced for viewing. As another example, images can appear next to auto-complete suggestions of products, such as those shown in the drop-down menu 130 of FIG. 1, allowing the user to view the image or several images before selecting the suggestion to add to inventory. In another example, an image can be sent to a user in a push notification regarding a recall. Push notifications in the context of this disclosure will be described presently.

In yet another embodiment of entering inventory, a user may take a photo or scan of the actual product itself using a smartphone camera, optical recognition scanner, or other similar image capture apparatus. FIG. 1 shows a “capture product image” button 160 for initiating an image capture process. The image may then be processed by optical recognition, converted into a digital representation, and compared to digital files of other images located in various databases or on the internet. Then, potential matched images and their associated product information can appear on the app, and the user can select which image and product information accurately matches the user's actual product. The use of other optical codes, such as QR codes, is also contemplated. Such codes may be read by QR scanners implemented using a camera in the user's mobile device, as known in the art. Often, QR codes have associated web addresses and prompt the launching of web browsers on a user's device. The mobile app may extract product information from the QR code itself or from an associated web site and import it into the mobile app itself in some embodiments.

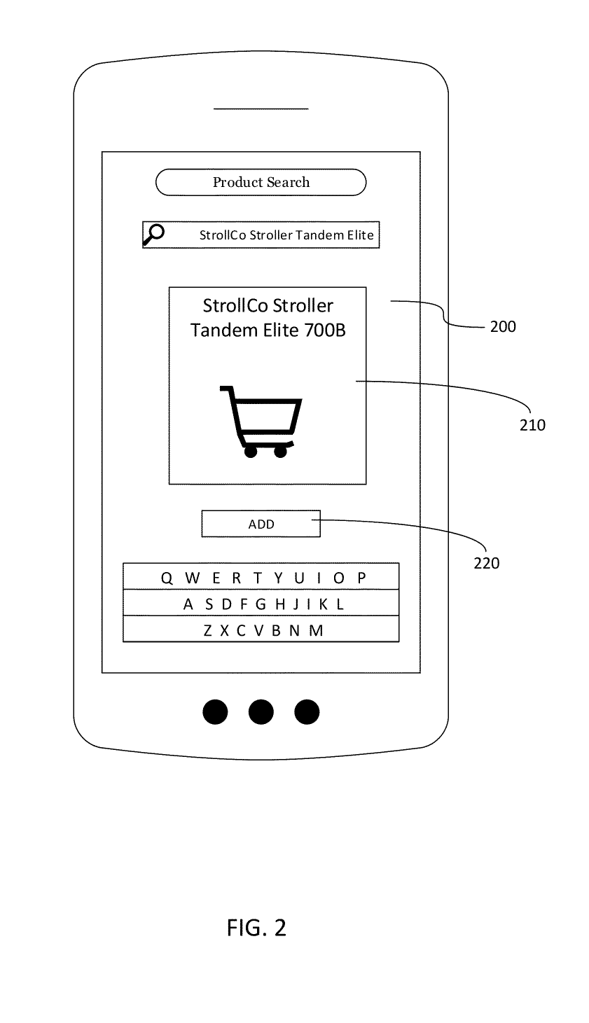

FIG. 2 shows a display of options on an “add product” screen 200 that may be presented to a user when a user has identified a matching product derived from the existing product databases 430 of FIG. 4. In many embodiments of the disclosure, the matching product may be displayed prominently with various types of identifying information. The product display icon 210 may contain, for example, an image of a product, a name, a model number, a serial number, a date of manufacture, manufacturer's information, and any other relevant product information. The add product screen 200 may include an add button 220 to allow a user to confirm the entry of the product into the user's inventory.

The add button 220 may also trigger a function of the application shown in FIG. 4 at 405, which is to compare the selected product to past recall databases 440. Past recall databases 440 may be hosted on dedicated servers for the mobile app and managed through the admin web app, or they may be located on third-party servers and managed by third-party sources. Past recall databases may include any reliable source of past recall information, such as government agencies, private consumer protection groups, or manufacturers. The ability to check against all past recalls in addition to future recalls can solve a common problem that occurs with recalls. Often, when a product is recalled, the effort made by the manufacturer and the recalling agency is sustained for a short period of time and then stops. As discussed earlier, traditional recall information campaigns have limited effectiveness. Manufacturers do not have a great incentive to continuously advertise their recalls because of the attendant loss of income and reputation. In some cases, a recalled product can cause a manufacturer to go out of business. As a result, many recalled products—even those with the most notorious defects—often stay on the market and in the hands of consumers for many years after the recall campaign has faded away. The recalled product may not exist in big retail stores that keep tabs on recalled products, but it may exist in small consignment stores, online, or simply in an unaware consumer's home. With the past recall lookup feature, parents can even enter hand-me-down products into their inventories and discover old recall information.

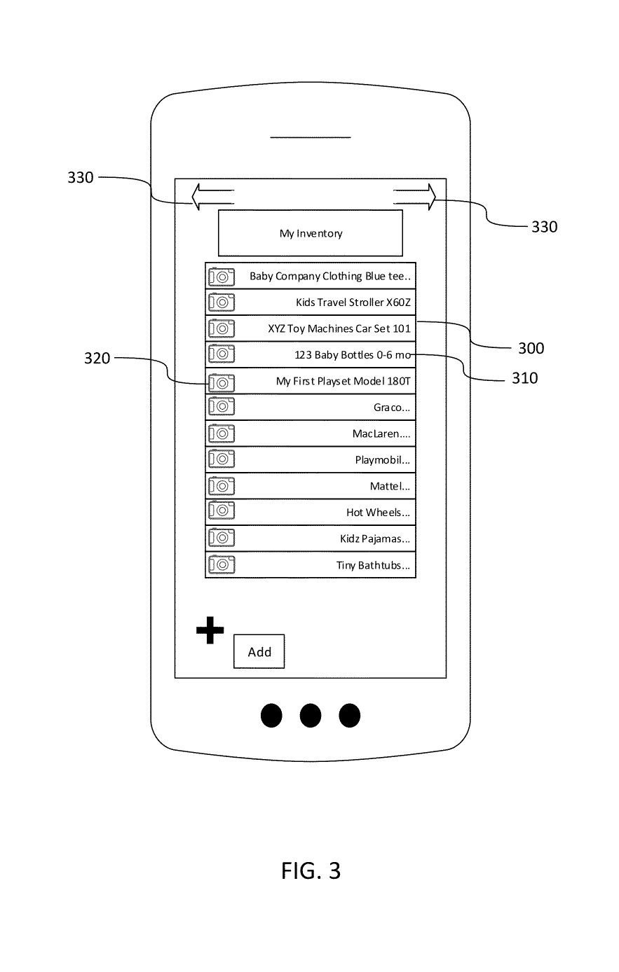

Another aspect of the disclosure is the display of the inventory. Turning to FIG. 3, shown is an exemplary user inventory 300, which may comprise product names 310 and product images 320. In some embodiments, the display can comprise a list, which can be organized in a variety of ways. For example, the list may be alphabetical or chronological. The list may be organized into sub-groups that categorize products by type. It is contemplated that a user's inventory may be extensive and require several pages for viewing. Various navigation tools such as forward and back buttons 330 may be implemented.

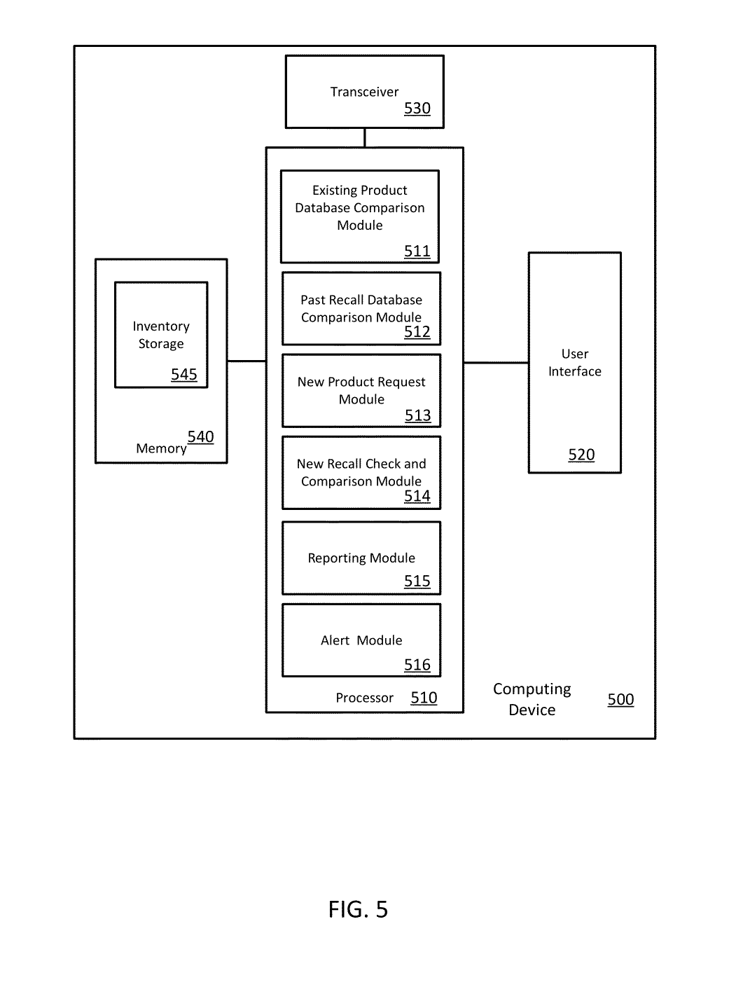

FIG. 4 shows systems and a method 400 for matching user inventory to past recalled products. While describing the method 400, simultaneous reference will be made to FIG. 5, which is a logical block diagram of a personal computing device 500 that may implement aspects of the method 400. FIG. 5 depicts logical connections between various components comprising hardware and software implemented in hardware. At 401, the method 400 may include receiving input from a user regarding a product name. The user may input all or a portion of the product name, as described with reference to FIG. 1. The input may be accomplished through a user interface 520 on the personal computing device 500. Then, at 402, the method may include searching existing product databases for products matching the product name, or the portion of the product name. This step may be implemented by an existing product database comparison module 511, which may be implemented by a hardware processor 510. Because the existing product databases 430 are stored outside the personal computing device 500 in many embodiments, the existing product database module may use the transceiver 530 to retrieve existing product database information through an internet data connection, for example. Existing product database comparison module 511 may utilize all or a portion of the received product name, a serial number, a model number, manufacturer name, barcode, optical recognition data, or any other received information in order to select the most likely product matches from the existing product databases 430.

Next, the method at 403 may include presenting matching product choices to the user for selection, via the user interface 520. A user may select the product through the user interface, which prompts the next step 404 of saving the user's selected product. As shown in FIG. 5, the selected product may be stored in an inventory storage 545 in a memory 540. The saving of the user's selected product 404 may then initiate the next step 405, which is to compare the selected product information to one or more past recall databases 440, via the past recall database comparison module 512. Because the past recall databases 440 may be stored outside of the device 500, the past recall database comparison module may access the past recall databases 440 through the transceiver 530. Similarly to the existing product database comparison module 511, the past recall database comparison module 512 may use any portion of the selected product information to check against the past recall databases, in order to ensure that any relevant past recall will be correctly matched.

It is contemplated that in some instances, some consumer products may not be available in existing product databases. This may occur, for example, if a new or small manufacturer of products makes their products available for sale to the public. Most consumer goods do not require any pre-approval from a government agency in order to be sold, so there is no universal registry of all consumer products. The existing product databases 430, therefore, may by compiled by researching information available to the public from manufacturers themselves. However, many new or small manufacturers might not have much information publically available. Consumers may purchase goods from any new or small retailer online, including handmade goods, and goods for children. Handmade craft retail websites are now a popular place to purchase such goods. Though there are some regulations on children's goods before they go to market, such regulations are difficult to enforce. As a result, goods made by small, independent manufacturers may be less likely to have been reviewed for conformance with product safety regulations In order to capture a more complete database of existing products, including new products and those manufactured by small companies, embodiments of the present disclosure also provide a new product request module and user interface. If a particular product is not found in an existing product database, the application may present the user with the option to request that a new product be added to the existing product databases 430. A user may input as much product information as the user has, and the new product request module 513 may send the information to the admin web app. An administrator of the web app may then take steps to verify the product information, add information as necessary, and add the product to the existing product databases 430. In some embodiments, the addition of the verified new product to the existing product database may also result in the product also being added to the requesting user's inventory.

The past recall database comparison module 512 may determine whether there is a past recall match at 406. If not, the user's selected product may remain in the inventory as shown at 407. If there is a past recall match, a visual alert is displayed to the user at 408. The visual alert may be generated within the application immediately by the alert module 516.

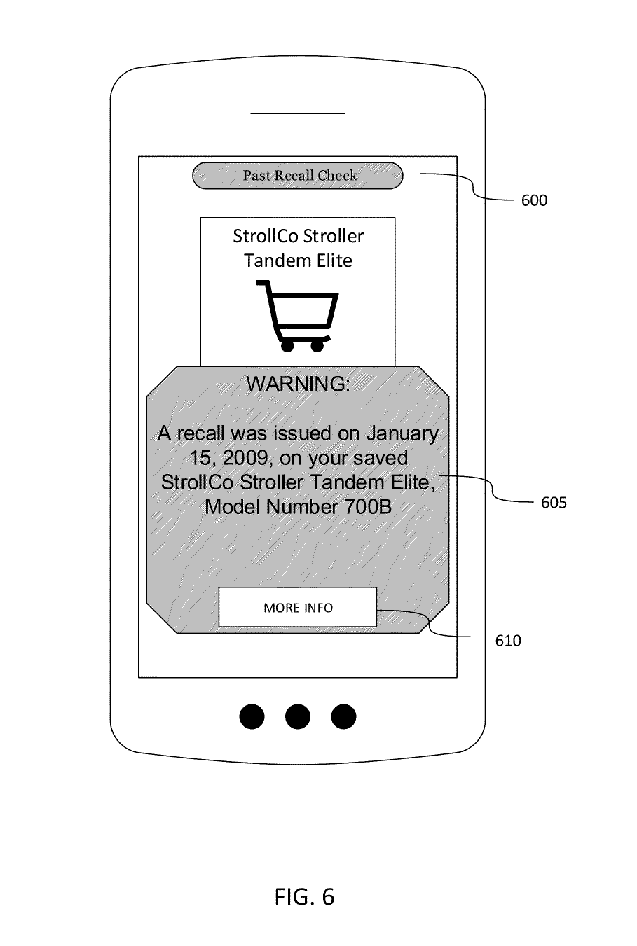

Referring to FIG. 6, shown is a past recall display screen 600 within the application. The visual alert 605 may initially display several pieces of pertinent information, including an image of the recalled product, the name, model number, and date of the recall. More or fewer details may be included on the visual alert in other embodiments. The visual alert 605 may be presented in a bright color, and may cover a large portion of the past recall display screen 600 in order to call the user's attention to the recall in an alarming manner. The visual alert 605 may also contain a “more info” button 610 to provide additional details regarding the dangers or defects present in the product and information about manufacturer's remedies. In some embodiments, part of the additional information displayed may include advertisements about replacement products that are available for purchase. Providing this additional information creates several benefits for users of the app as well as for product manufacturers. For example, if a recall occurred a long time ago and the original remedy provided by the manufacturer is impractical or no longer available, the user may wish to know about replacement products to buy instead. A product manufacturer of the particular past recalled product may be able to advertise its own improved replacement products along with the recall information. The past recall notification itself mitigates continuing liability for the manufacturer, and the advertisement and opportunity to sell a different product may mitigate losses of business resulting from the past recall. Alternatively, competitive manufacturers to the manufacturer of the past recalled product may use the advertising to gain an opportunity if the recall of the original product motivates a user to want to switch brands entirely.

It is contemplated that in some embodiments, the past recall database comparison module 512 may take a longer time to check against the past recall databases 440 than the user will spend in the application. For example, a user may wish to add a product, save it to the inventory, and then exit the application. If the past recall database comparison module 512 has not yet completed the past recall database check when the user has exited the application, the check may still run in the background. If a past recall is identified after the user has closed the application, the alert module 516 may still send a visual alert to a user by generating a push notification to the user. As discussed herein, a push notification may be of the types known in the art that appear superimposed upon a user's other applications or on a home screen to call attention to something the user would probably like to know immediately. In some embodiments, a user may still be able to keep the product listed in inventory even though it has been recalled. In such embodiments, a visual designation may be displayed alongside the product to remind the user that the product has been recalled. In other embodiments, the user may not be able to add the past recalled product to the inventory after the user has received the past recall warning, in order to encourage the user to fix or get rid of the product.

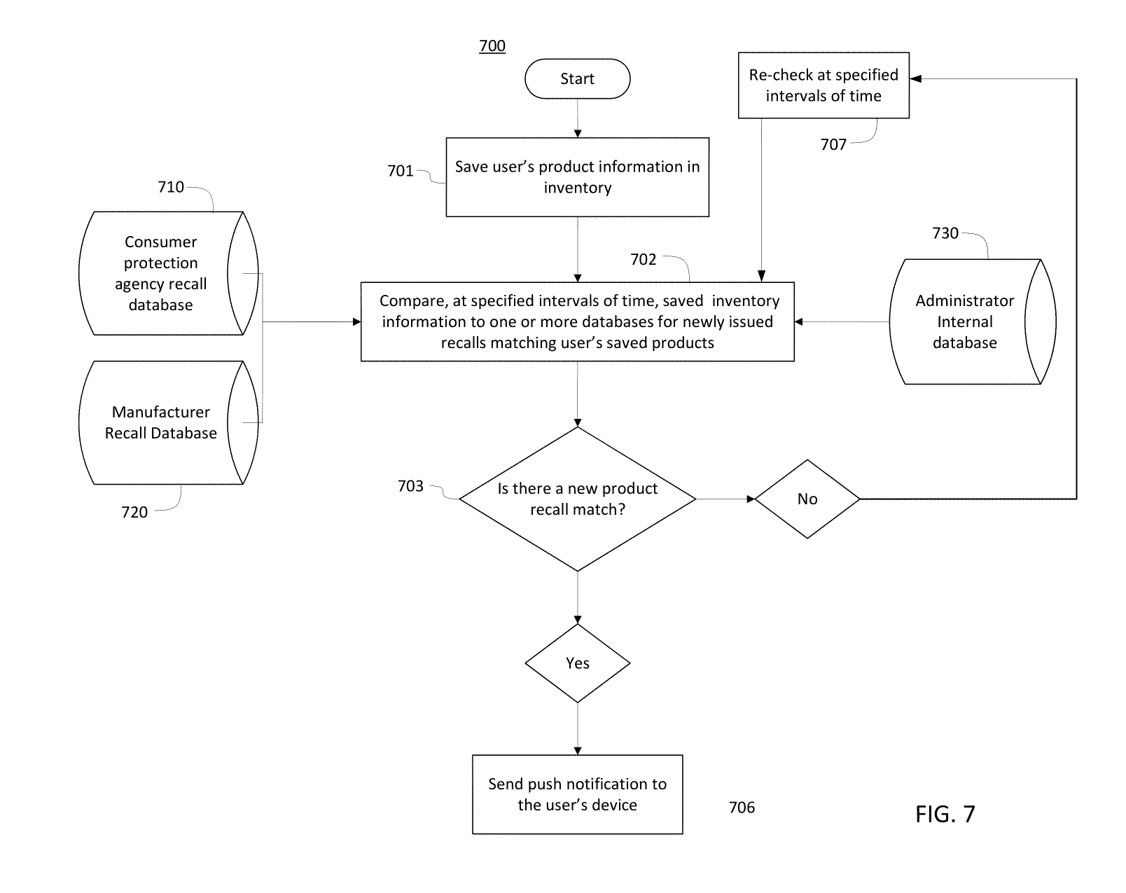

Referring now to FIG. 7, shown is a method 700 for checking a user's stored products against newly issued recalls continuously and periodically at a specified interval of time. Simultaneous reference may will be made to FIG. 5 to discuss various modules that may implement parts of the method. At 701, a user's product information is saved. The method 400 described with reference to FIG. 4 may comprise the method by which product information is saved at 701. At 702, saved products in inventory are compared at specified intervals of time to one or more databases for newly issued recalls matching the user's saved products. This comparison may be implemented by a new recall check and comparison module 514. It is contemplated that the new recall check may be specified to occur daily at a particular time, such as noon, or 9 am for example. Longer or shorter intervals of time are contemplated. If the interval is daily, the notification time of day may be set by a user, the application may have a default time of day. The interval itself (i.e., hourly, daily, twice a day, twice a week) may be set by an administrator of the application in order to ensure that new recall information is sent to users of the application in a timely manner. Though it is contemplated that any time interval may be set by an administrator, it is likely that most embodiments will have an interval of at least once a day; substantially longer intervals would unnecessarily increase the risk of a user not being notified of a recall in a timely manner.

The new recall check and comparison module 514 may check against one or more recall databases that are periodically updated with new recall information. Such databases may include those published by government agencies, such as a consumer protection agency's recall database 710. Additionally or alternatively, one or more manufacturer's recall databases 720 may be used. It is contemplated that an administrator of the application may maintain a database, such as an admin web app internal database 730. An administrator of the application itself may have incentive to make sure its internal database 730 is as up-to-date and technically sound so that the application delivers recall information reliably.

If the new recall check and comparison module 514 determines that there is a new product recall match at 703, the alert module 516 may generate a push notification to the user's device at 706. If there is no new recall, the new recall check and comparison module 514 re-checks and starts the process again at 707 at the next specified interval of time.

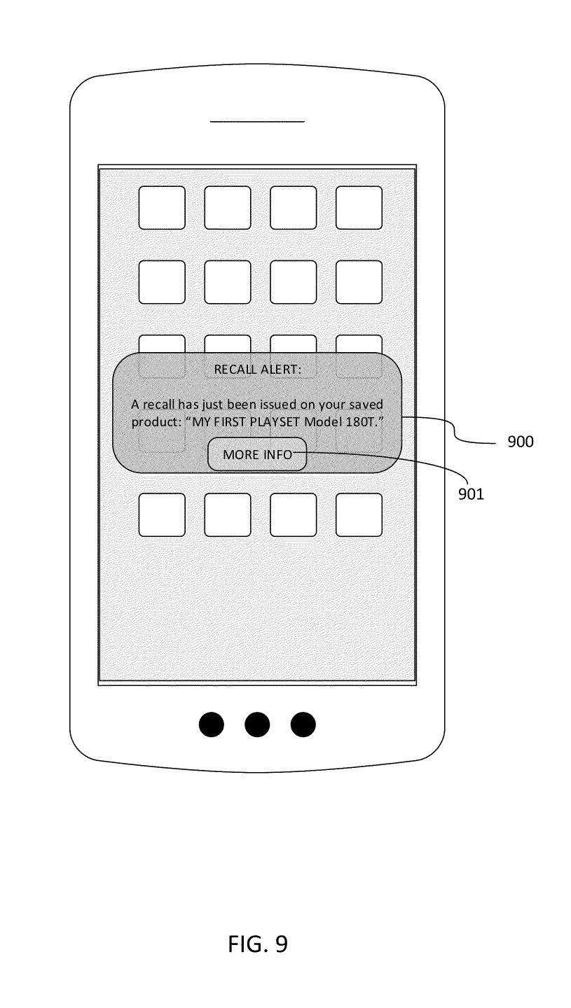

Other aspects of this disclosure pertain to systems and methods to increase the likelihood that users will receive and pay attention to relevant recall information. Whenever an inventory product is matched with a newly issued recall, a push notification is sent to the user's mobile device. FIG. 9 shows a push notification 900. A push notification is the kind known in the art; it a window with text that is temporarily superimposed on the user's home screen or on whatever application is open at the time, and sometimes with an image, sound, or vibration. The push notification 900 can include the product name, model number, and image of the recalled product. It can also include a button for more info 901 that may open the application itself and provide more detailed information as described throughout the disclosure, such as the nature of the defect or danger, the manufacturer remedy, actions the user should take, and advertising information about related products. The push notification 900 can be accompanied by a sound that is more alarming than a standard push notification in order to call the user's attention to the importance of a notification. The use of alarming sounds for recall notifications can be similar to the alarming sounds that sometimes accompany severe weather alert push notifications implemented by some emergency broadcast systems.

In some embodiments, the user can remove products from their inventories. This feature allows users to ensure that they will not receive alerts for products that they no longer have. Although it is not necessary for users to remove products, the feature creates another opportunity for users to interact with the app.

The admin web app can be configured to receive all product recall information as it comes out from various agencies, and proactively push it out to users whose inventory contains a match for a particular product. For example, the admin web app can flag recalls that affect a certain threshold number of products and push them out immediately (rather than at a regularly scheduled check at the specified interval of time) to affected consumers. Say, for example, that the administrator of the web app determines that a major recall is one that affects over 500,000 products. Whenever such a recall occurs, the admin web app may scan all user's inventories for affected products and initiates an immediate push notification to all those who own the product. One benefit to sending out immediate notifications is that a user may pay more attention to a notification that is sent at an unusual time in comparison to when a user normally receives push notifications from the app. Another benefit is that even a few days or hours of extra notice can encourage vigilance and action by the consumers who own the product that they wouldn't have exercised had they not known about the recall.

In another embodiment, the system can send out alerts of unusually large or unusually dangerous recalls to consumers regardless of whether the consumer owns the product. Say, for example, that a recall affects over 1 million products, or that deaths have caused the recall of a particular product. The system can send out push notifications to all users of the mobile app. One benefit is that the recall notice can prevent a consumer from buying a very popular recalled product in the first place. Another benefit is that the notice can increase the likelihood that non-users of the mobile application will find out about the recall. Parents of young children often have large peer groups of other parents with children of the same age. Word-of-mouth marketing is highly effective among parent groups, and if a few members of the group are users of the mobile app, they may mention the news of a large recall to other members of their group that do not use the mobile app. In some embodiments, the push notification for this particular kind of recall can specify that the user does not own the product, but that is a popular and widely used product, and the notification may encourage the user to tell other consumers about it.

In another embodiment of the disclosure, the mobile app can maintain a viewable list of all recently recalled products, regardless of whether they are in the user's inventory. Because parents may not remember or take the time to enter every single product or item of clothing that they obtain for their children, this list can provide easy, on-demand access to all recall information when a parent has time to look at the application. Such a list of all recently recalled products may be made available through one or more of the consumer protection agency recall database 719, the manufacturer recall database 720, and the administrator internal database 730.

Other aspects of the disclosure are directed toward engaging users in ongoing participation with the mobile application over the course of several years. In some embodiments, the mobile application sends various push notifications with safety information that is not directly related to recalls, but which are related to child safety and provide value to users and remind them of the application. For example, the system can receive health and safety bulletins published by the USDA or the FDA regarding E.coli contamination or drug recalls.

In some embodiments, the system can send push notifications with general safety tips every month. The tips can be topical depending on the time of the year. For example, in June and December, the tip can be a semi-annual reminder to check and replace smoke detector and carbon monoxide detector batteries. In July, the tip can be about fireworks safety. In October, the tip can be about Halloween safety. Such push notifications can be helpful safety reminders in and of themselves, but they can also serve as gentle reminders to the user that they have a useful application they should regularly interact with.

Another aspect of the disclosure is a method for the user to report product defects or dangerous events associated with a product through the application to consumer protection agencies, such as the Consumer Protection Safety Commission or to the website www.recalls.gov. In some implementations, there is a product defect or danger reporting interface within the mobile app, which may be implemented by a reporting module 515 as show in in FIG. 5. Once a user has entered the relevant information into the interface, the reporting module 515 can generate an e-mail to a reporting address. The reporting address or addresses can be stored on the admin web app and need not be known to the user. In other implementations, the reporting module 515 can fill out a reporting web form on behalf of the consumer with the relevant information. The reporting web site information can be stored on the admin web app and need not be known to the user. The reporting interface aspect of this disclosure allows users to take immediate action, which can increase the engagement of the user with the application. Additionally, the reporting module 515 may use product information stored in the user's inventory to automatically fill out a form for the report, which can make reporting more convenient for a user by not requiring the user to manually enter the information. Using the stored inventory information may make the reporting more accurate, because the inventory information will already include details such as a model number and perhaps a serial number as well. Typically, consumer protection agencies discover products that require investigation through direct consumer complaints or through manufacturer reporting of consumer complaints. Many consumers do not know to whom they should report a product complaint. Consumer protection websites and phone numbers are not well known, and if consumers report to manufacturers instead, there can be a delay in the manufacturer relaying the information to the consumer protection agency. It is advantageous to have a convenient, accurate, streamlined reporting function because it increases the likelihood and frequency of reporting, and potentially increases the speed of manufacturers and agencies discovering product defects and dangers.

Yet another aspect of the disclosure is that the mobile app can contain local emergency phone numbers, such as the numbers of poison control, police department, and fire department. In some embodiments, the mobile app can use local information obtained by GPS location services that exist on the mobile device.

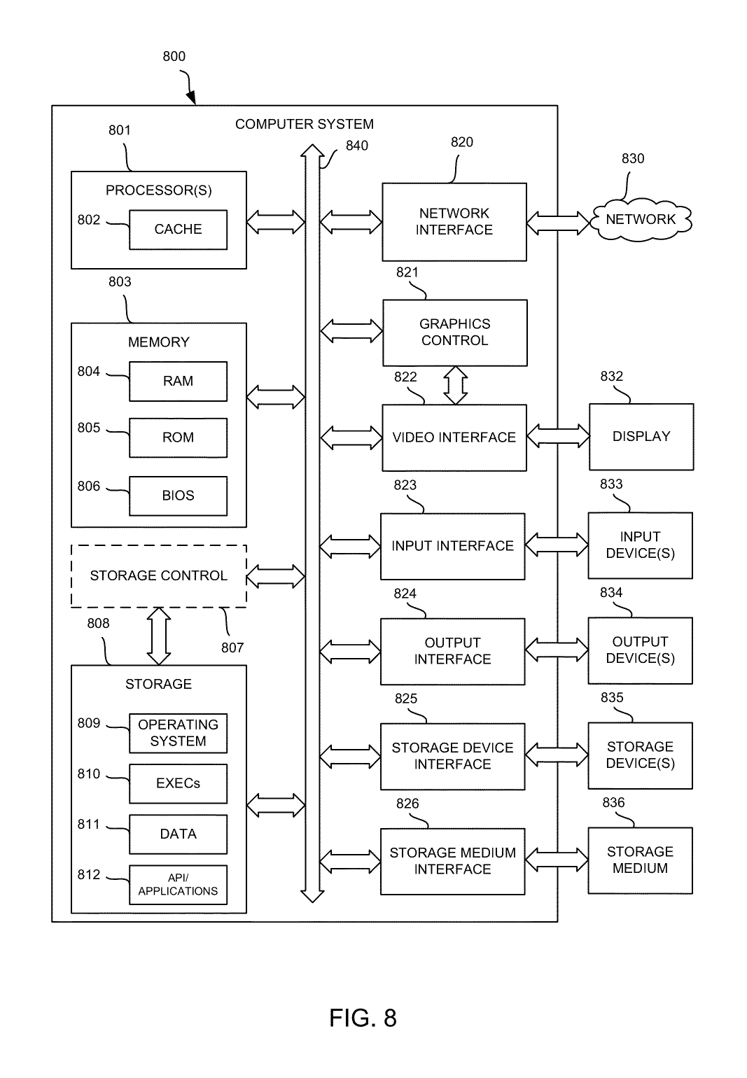

The systems and methods described herein can be implemented in a computer system in addition to the specific physical devices described herein. FIG. 8 shows a diagrammatic representation of one embodiment of a computer system 800 within which a set of instructions can execute for causing a device to perform or execute any one or more of the aspects and/or methodologies of the present disclosure. The components in FIG. 8 are examples only and do not limit the scope of use or functionality of any hardware, software, firmware, embedded logic component, or a combination of two or more such components implementing particular embodiments of this disclosure.

Computer system 800 includes at least a processor 801 such as a central processing unit (CPU) or an FPGA to name two non-limiting examples. The computer system 800 may also comprise a memory 803 and a storage 808, both communicating with each other, and with other components, via a bus 840. The bus 840 may also link a display 832, one or more input devices 833 (which may, for example, include a keypad, a touchscreen, a keyboard, a mouse, a stylus, etc.), one or more output devices 834, one or more storage devices 835, and various non-transitory, tangible computer-readable storage media 836 with each other and with one or more of the processor 801, the memory 803, and the storage 808. All of these elements may interface directly or via one or more interfaces or adaptors to the bus 840. For instance, the various non-transitory, tangible computer-readable storage media 836 can interface with the bus 840 via storage medium interface 826. Computer system 800 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 801 (or central processing unit(s) (CPU(s))) optionally contains a cache memory unit 802 for temporary local storage of instructions, data, or computer addresses. Processor(s) 801 are configured to assist in execution of computer-readable instructions stored on at least one non-transitory, tangible computer-readable storage medium. Computer system 800 may provide functionality as a result of the processor(s) 801 executing software embodied in one or more non-transitory, tangible computer-readable storage media, such as memory 803, storage 808, storage devices 835, and/or storage medium 836 (e.g., read only memory (ROM)). For instance, the method in FIG. 3 may be embodied in one or more non-transitory, tangible computer-readable storage media. The non-transitory, tangible computer-readable storage media may store software that implements particular embodiments, such as the methods of matching recalls to products, sending information to users and sending consumer reports to agencies, and processor(s) 801 may execute the software. Memory 803 may read the software from one or more other non-transitory, tangible computer-readable storage media (such as mass storage device(s) 835, 836) or from one or more other sources through a suitable interface, such as network interface 820. The software may cause processor(s) 801 to carry out one or more processes or one or more steps of one or more processes described or illustrated herein. Carrying out such processes or steps may include defining data structures stored in memory 803 and modifying the data structures as directed by the software. In some embodiments, an FPGA can store instructions for carrying out functionality as described in this disclosure (e.g., the methods of matching recalls to products, sending information to users and sending consumer reports to agencies). In other embodiments, firmware includes instructions for carrying out functionality as described in this disclosure (e.g., the methods referenced above).

The memory 803 may include various components (e.g., non-transitory, tangible computer-readable storage media) including, but not limited to, a random access memory component (e.g., RAM 804) (e.g., a static RAM “SRAM”, a dynamic RAM “DRAM, etc.), a read-only component (e.g., ROM 805), and any combinations thereof. ROM 805 may act to communicate data and instructions unidirectionally to processor(s) 801, and RAM 804 may act to communicate data and instructions bidirectionally with processor(s) 801. ROM 805 and RAM 804 may include any suitable non-transitory, tangible computer-readable storage media described below. In some instances, ROM 805 and RAM 804 include non-transitory, tangible computer-readable storage media for carrying out the methods referenced above. In one example, a basic input/output system 806 (BIOS), including basic routines that help to transfer information between elements within computer system 800, such as during start-up, may be stored in the memory 803.

Fixed storage 808 is connected bidirectionally to processor(s) 801, optionally through storage control unit 807. Fixed storage 808 provides additional data storage capacity and may also include any suitable non-transitory, tangible computer-readable media described herein. Storage 808 may be used to store operating system 809, EXECs 810 (executables), data 811, API applications 812 (application programs), and the like. For instance, the storage 808 could be implemented for storage of an inventory, list, user database, or other product database. Often, although not always, storage 808 is a secondary storage medium (such as a hard disk) that is slower than primary storage (e.g., memory 803). Storage 808 can also include an optical disk drive, a solid-state memory device (e.g., flash-based systems), or a combination of any of the above. Information in storage 808 may, in appropriate cases, be incorporated as virtual memory in memory #03.

In one example, storage device(s) 835 may be removably interfaced with computer system 800 (e.g., via an external port connector (not shown)) via a storage device interface 825. Particularly, storage device(s) 835 and an associated machine-readable medium may provide nonvolatile and/or volatile storage of machine-readable instructions, data structures, program modules, and/or other data for the computer system 800. In one example, software may reside, completely or partially, within a machine-readable medium on storage device(s) 835. In another example, software may reside, completely or partially, within processor(s) 801.

Bus 840 connects a wide variety of subsystems. Herein, reference to a bus may encompass one or more digital signal lines serving a common function, where appropriate. Bus 840 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 800 may also include an input device 833. In one example, a user of computer system 800 may enter commands and/or other information into computer system 800 via input device(s) 833. Examples of an input device(s) 833 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 833 may be interfaced to bus 840 via any of a variety of input interfaces 823 (e.g., input interface 823) including, but not limited to, serial, parallel, game port, USB, FIREWIRE, THUNDERBOLT, or any combination of the above.

In particular embodiments, when computer system 800 is connected to network 830, computer system 800 may communicate with other devices, such as mobile devices and enterprise systems, connected to network 830. Communications to and from computer system 800 may be sent through network interface 820. For example, network interface 820 may receive incoming communications (such as requests or responses from other devices) in the form of one or more packets (such as Internet Protocol (IP) packets) from network 830, and computer system 800 may store the incoming communications in memory 803 for processing. Computer system 800 may similarly store outgoing communications (such as requests or responses to other devices) in the form of one or more packets in memory 803 and communicated to network 830 from network interface 820. Processor(s) 801 may access these communication packets stored in memory 803 for processing.

Examples of the network interface 820 include, but are not limited to, a network interface card, a modem, and any combination thereof. Examples of a network 830 or network segment 830 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 830, may employ a wired and/or a wireless mode of communication. In general, any network topology may be used.

Information and data can be displayed through a display 832. Examples of a display 832 include, but are not limited to, a liquid crystal display (LCD), an organic liquid crystal display (OLED), a cathode ray tube (CRT), a plasma display, and any combinations thereof. The display 832 can interface to the processor(s) 801, memory 803, and fixed storage 808, as well as other devices, such as input device(s) 833, via the bus 840. The display 832 is linked to the bus 840 via a video interface 822, and transport of data between the display 832 and the bus 840 can be controlled via the graphics control 821.

In addition to a display 832, computer system 800 may include one or more other peripheral output devices 834 including, but not limited to, an audio speaker, a printer, and any combinations thereof. Such peripheral output devices may be connected to the bus 840 via an output interface 824. Examples of an output interface 824 include, but are not limited to, a serial port, a parallel connection, a USB port, a FIREWIRE port, a THUNDERBOLT port, and any combinations thereof.

In addition or as an alternative, computer system 800 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Within this specification, the same reference characters are used to refer to terminals, signal lines, wires, etc. and their corresponding signals. In this regard, the terms “signal,” “wire,” “connection,” “terminal,” and “pin” may be used interchangeably, from time-to-time, within the this specification. It also should be appreciated that the terms “signal,” “wire,” or the like can represent one or more signals, e.g., the conveyance of a single bit through a single wire or the conveyance of multiple parallel bits through multiple parallel wires. Further, each wire or signal may represent bi-directional communication between two, or more, components connected by a signal or wire as the case may be.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, or microcontroller. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein (e.g., the methods of matching recalls to products, sending information to users and sending consumer reports to agencies) may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for delivering product safety information using an application
on a personal computing device, the method comprising:
receiving, as a result of a user-initiated action, at least a portion of a product name of a product,
searching a database of existing products for existing products matching the at least a portion of the product name,
presenting, to a user, if one or more matching products is found in the database of existing products, an option to select one of the one or more matching products to save,
receiving a selection from the user of one of the one or more matching products,
saving one of the one or more matching products selected by the user in an inventory in a memory, thereby creating a saved product,
comparing the saved product to one or more databases of past recalled products,
presenting, if a past recall of the saved product is found in the one or more databases, a notification to the user,
accessing one or more new recall databases continuously at specified intervals of time in order to identify new recalls issued against the saved product,
creating a visual alert to the user if a new recall is issued against the saved product.

2. The method of claim 1, wherein the user-initiated action is selected from one of:
scanning a code associated with the product name, typing the at least a portion of the product name in a search field on the user interface, and
capturing a digital image of the product, identifying the product name through digital optical recognition.

3. The method of claim 1, further comprising:
determining whether a particular new recalled product identified from the one or more new recall databases affects a number of sold products exceeding a threshold, and
if the number exceeds the threshold, sending an alert to a user who has saved at least one saved product, but who has not saved the particular new recalled product.

4. The method of claim 1, further comprising:
providing manufacturer instructions regarding the return or replacement of the saved product that has had the new recall issued against it.

5. The method of claim 1, further comprising:
requesting that the user acknowledge receipt of the visual alert, and
providing information about at least one replacement product available for purchase in response to the user acknowledging receipt of the visual alert.

6. The method of claim 1, further comprising:
providing a view of a list on a user interface, of one or more products previously saved by the user, the list comprising at least the saved product, and
presenting, to the user, an option to select at least one of the one or more products for reporting a defect or incident related to a selected product,
receiving, from the user, through the user interface, information regarding the defect or incident related to the selected product,
sending a name of the selected product and the information regarding the defect or incident to one or more of:
an administrator interface of the application,
a governmental regulatory agency, and
a manufacturer of the selected product.

7. The method of claim 1, further comprising:
presenting, if no matching product is found in the database of existing products, a new product request interface to the user, wherein the new product request interface allows the user to enter a name and manufacturer of a new product,
generating a new product validation request to add the new product to the database of existing products,
validating the new product,
adding the new product to the existing product database, and
adding the new product to the inventory.

8. A system for providing product safety information, the system comprising:
a personal computing device comprising;
a user interface for inputting at least a portion of a product name,
an application implemented on a hardware processor, the application comprising:
an existing product database comparison module,
a past recall database comparison module,
a new recall check and comparison module,
an alert module,
a memory for storing an inventory, and
a transceiver;
at least one existing product database,
at least one past recall database, and
at least one new recall database.

9. The system of claim 8, wherein the application further comprises:
a reporting module.

10. The system of claim 8, wherein the personal computing device comprises a camera.

11. A non-transitory, tangible computer readable storage medium, encoded with processor readable instructions to perform a method for delivering product safety information using an application on a personal computing device, the method comprising:
receiving, as a result of a user-initiated action, at least a portion of a product name of a product,
searching a database of existing products for existing products matching the at least a portion of the product name,
presenting, to a user, if one or more matching products is found in the database of existing products, an option to select one of the one or more matching products to save,
receiving a selection from the user of one of the one or more matching products,
saving one of the one or more matching products selected by the user in an inventory in a memory, thereby creating a saved product,
comparing the saved product to one or more databases of past recalled products,
presenting, if a past recall of the saved product is found in the one or more databases, a notification to the user,
accessing one or more new recall databases continuously at specified intervals of time in order to identify new recalls issued against the saved product,
creating a visual alert to the user if a new recall is issued against the saved product.

12. The non-transitory, tangible computer readable storage medium of claim 11, wherein the user-initiated action is selected from one of:
scanning a code associated with the product name,
typing the at least a portion of the product name in a search field on the user interface, and
capturing a digital image of the product, identifying the product name through digital optical recognition.

13. The non-transitory, tangible computer readable storage medium of claim 11, wherein the method includes:
determining whether a particular new recalled product identified from the one or more new recall databases affects a number of sold products exceeding a threshold, and
if the number exceeds the threshold, sending an alert to a user who has saved at least one saved product, but who has not saved the particular new recalled product.

14. The non-transitory, tangible computer readable storage medium of claim 11, wherein the method includes:
providing manufacturer instructions regarding the return or replacement of the saved product that has had the new recall issued against it.

15. The non-transitory, tangible computer readable storage medium of claim 11, wherein the method includes:
requesting that the user acknowledge receipt of the visual alert, and
providing information about at least one replacement product available for purchase in response to the user acknowledging receipt of the visual alert.

16. The non-transitory, tangible computer readable storage medium of claim 11, wherein the method includes:
providing a view of a list on a user interface, of one or more products previously saved by the user, the list comprising at least the saved product, and
presenting, to the user, an option to select at least one of the one or more products for reporting a defect or incident related to a selected product,
receiving, from the user, through the user interface, information regarding the defect or incident related to the selected product,
sending a name of the selected product and the information regarding the defect or incident to one or more of:
an administrator interface of the application,
a governmental regulatory agency, and
a manufacturer of the selected product.

17. The non-transitory, tangible computer readable storage medium of claim 11, wherein the method includes:
presenting, if no matching product is found in the database of existing products, a new product request interface to the user, wherein the new product request interface allows the user to enter a name and manufacturer of a new product,
generating a new product validation request to add the new product to the database of existing products,
validating the new product,
adding the new product to the existing product database, and
adding the new product to the inventory.
